(19) United States
(12) Patent Application Publication
(10) Pub. No.: US 2016/0093992 A1
(43) Pub. Date: Mar. 31, 2016

(54) UNIVERSAL SERIAL BUS CONNECTOR

(71) Applicant: ANFU CE LINK LIMITED, JIAN CITY (CN)

(72) Inventor: HONG LIANG ZHOU, HONGFENG CITY (CN)

(21) Appl. No.: 14/548,234

(22) Filed: Nov. 19, 2014

(30) Foreign Application Priority Data
Sep. 26, 2014 (CN) 201420558760.X

(51) Int. Cl. H01R 24/60

(52) U.S. Cl. CPC H01R 24/60

(57) ABSTRACT

The instant disclosure provides a USB connector that comprises a shell element, a printed circuit board (PCB), and a USB head. The USB head is arranged at an end of the shell element. The USB head has a board slot arranged therein. Two opposite surfaces of the PCB each have a plurality of conductive contacts disposed thereon. The PCB is disposed in the board slot. The USB connector can be in electrical contact with a USB female receptacle via the conductive contacts on opposite surfaces of the PCB. The USB connector can be used directly without distinguishing the appropriate side of the USB connector to plug into a female USB receptacle.

### BACKGROUND OF THE INVENTION

1. Field of the Invention

The instant disclosure relates to a universal serial bus connector; in particular, to a universal serial bus (USB) connector.

2. Description of Related Art

As digital and communication equipment become widely applicable, the need to import or export data as well as electrically charging digital communication products become more and more important. However, the conventional USB connectors typically couples a female connector (the receptacle) to a male connector (the plug) in a “top-bottom” configuration, which hinders the coupling and decoupling of the USB connectors since users are required to first determine the correct orientation of the plug and the receptacle before plugging. Moreover, the manufacturing method of the conventional USB connectors is complex, in which the USB connectors are formed by stamping metallic plates and metal contacts are inlaid into the metallic plates that yield high production costs.

To address the above issues, the inventor strives via associated experience and research to present the instant disclosure, which can effectively improve the limitation described above.

### SUMMARY OF THE INVENTION

The objective of the instant disclosure is to provide a USB connector having simple structures, low costs, and simple to use.

In order to achieve the aforementioned objectives, according to an embodiment of the instant disclosure, a USB connector, comprising a shell element, a printed circuit board, a USB head, and a data transmission cable. The shell element has a shell slot arranged at one end thereof. The data transmission cable is connected to another end of the shell element. The printed circuit board (PCB) has a plurality of conductive contacts arranged on two surfaces thereof, also known as double-sided PCB. The conductive contacts are electrically connected to the data transmission cable. The USB head has a board end and a receptacle end. The board end has a frame and the receptacle end has two side panels and a crossbeam. The frame, portions of the printed circuit board, and portions of the side panels are arranged in the shell element. Moreover, the frame has portions defining an opening, two side panels extend from the frame and the crossbeam is transversally interposed between two tips of the two side panels such that the panels are spaced apart to define a board slot in air communication with the opening. One end of the printed circuit board is arranged in the opening and another end of the printed circuit board is peripherally retained in the board slot. The shell slot conforms to a combined cross-sectional area of the printed circuit board and the two side panels such that the shell slot encapsulates the frame, and sheathes portions of the printed circuit board and portions of the two side panels. In addition, the printed circuit board is fixed in the opening at a geometrical center of the frame.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an exploded view of a USB connector in accordance with the instant disclosure; and

FIG. 2 is a schematic diagram illustrating the operating mode of the USB connector in accordance with the instant disclosure.

### DETAILED DESCRIPTION OF THE PREFERRED EMBODIMENTS

The aforementioned illustrations and detailed descriptions are exemplary for the purpose of further explaining the scope of the instant disclosure. Other objectives and advantages related to the instant disclosure will be illustrated in the subsequent descriptions and appended drawings.

The instant disclosure provides a USB connector, which has substantially the same functionality as a standard universal serial bus (USB) type-A male connector or plug, is compatible with a standard universal serial bus (USB) type-A female connector or receptacle, and is applicable to the typical USB connectors. The USB connector of the instant disclosure differs from the conventional USB male connectors in structural and pin contact designs while retaining the manner and principle of data and power transmission, thus, compatibility with the conventional female USB receptacles is not affected as both sides of male USB plug provided by the instant disclosure can be conveniently coupled to the conventional USB female receptacles.

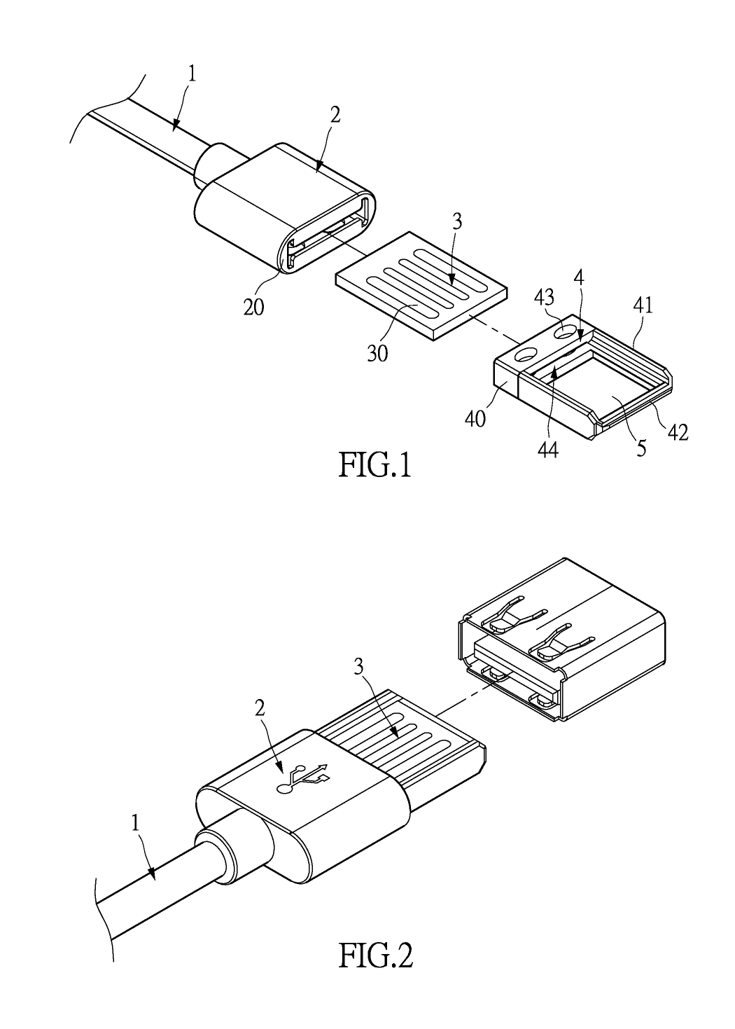

Please refer to FIG. 1 as an exploded view of a USB connector in accordance with the instant disclosure. The USB connector C includes a data transmission cable 1, a shell element 2, a printed circuit board (PCB) 3, a USB head 4, and a board slot 5. The data transmission cable 1 can be a standard USB 1.x or USB 2.x cables, in which a twisted pair of wires is used to reduce noise and crosstalk. Alternatively, the data transmission cable 1 can also be a USB 3.0 cable that contains twice as many wires as USB 2.x to support SuperSpeed data transmission. The USB 1.x or USB 2.x cable has a length ranges between 3 to 5 meters and is made of standard copper wire, whereas the USB 3.0 cables can be for example AWG (American Wire Gauge) 26 wires made of copper with an overall length of about 3 meters. The data transmission cable 1 is electrically connected to conductive contacts within the shell element 2. Specifically, the shell element 2 has a shell slot 20. The shell element 2 encloses all electrical connections between the data transmission cable 1 and the PCB 3.

The PCB 3 is substantially a flat dielectric substrate having a plurality of spaced apart through holes and a plurality of conductive contacts 30 arranged on two opposite surfaces of the PCB 3. The conductive contacts 30 can be flat metallic plates or films. In the instant embodiment, at least four conductive contacts 30 are respectively disposed in the four through holes on one surface, and another four conductive contacts 30 are respectively disposed in the four through holes on the other surface, so that four contacts 30 on one surface of the double sided PCB 3 are respectively connected to four superimposed contacts 30 on the other surface of the double sided PCB 3. Thus, the PCB 3 is also known as a double sided PCB 3. In order to superimpose contacts 30 on one surface of the double sided PCB 3 over the contacts on the other surface, traces are properly rearranged. The thin and flat double-sided PCB 3 has a thickness of approximately 1.2 mm. Due to the thin and double sided conductive contacts 30 on the PCB 3, the standard female USB counterpart can make physical contact and therefore data and electrical communication with the male USB plug U of the instant disclosure regardless of the orientation with respect to each other. Specifically, the male USB plug U can be inserted into the female USB receptacle regardless of which surface of the PCB 3 that the PCB of the female USB receptacle makes physical contact with. Since both surfaces of the PCB 3 have superimposed conductive contacts 30, the conductive contacts on the female receptacle can make physical contact with the conductive contacts 30 that are arranged on either surface of the PCB 3.

The USB head 4 has two ends, a board end and a receptacle end. The board end has a frame 40, which can be a hollowed rectangular frame (shown but not labeled) or two flat plates having an opening 44 therebetween to clamp the PCB 3, mechanically engaged to and encapsulated in the shell element 2. The PCB 3 is fixed at the frame 40 in the opening 44 via at least one through hole 43 formed on frame 40 and a fixing member (not shown in figures), such as a screw. The PCB 3 is manually or mechanically fixed at a geometric center with respect to the frame 40. Two side panels 41 extend away from the frame 40 and are spaced apart from one another by a crossbeam 42 that is transversely interposed between the tips of the panels 41 to define a board slot 5. Since the opening 44 is in air communication with the board slot 5, the frame 40 and the board slot 5 cooperatively retain the PCB 3 at a geometric center with respect to the frame 40. Specifically, the frame 40 retains the PCB 3 at one end, a transmission end, in a cantilever manner while the board slot 5 defined by the side panels 41 and the crossbeam 42 peripherally retains the PCB 3 at another end, a head end, of the PCB 3. Together, the frame 40 and the board slot 5 securely retain one end of the PCB 3 at a geometric center with respect to the frame 40 to provide a tightly packaged unit. Specifically, after the data transmission cable 1 is electrically connected, i.e. through soldering, to conductive contacts 30 on the transmission end of the PCB 3, the PCB 3 is disposed into a molding for mold injection to provide a tightly packaged unit. The USB head 4 is integrally formed, in which acrylonitrile butadiene styrene (ABS) is injected into a molding, over the PCB 3. The head 4 has a width of approximately 12.1 mm measured from one side panel 41 to another and a thickness of approximately 3.5 mm, whereas the crossbeam 42 has a thickness of approximately 1.3 mm.

In order to fit the packaged unit into the shell element 2, the shell slot 20 has a specific shape conforming to the packaged unit. The slot 20 has portions proximate to the brim of the slot 20 that has a specific outline conforming to a combined cross-sectional area of the PCB 3 and the side panels 41, such that when the PCB 3 along with the USB head 4 is coupled to the shell slot 20, the outline at portions of the slot 20 near the brim conformingly sheathes portions of the side panels 41 and the PCB 3, whereas the frame 40 is completely concealed in the shell element 2 as shown in FIG. 2. In the instant embodiment, the combined cross-sectional area of the PCB 3 and the side panels 41 as well as the specific outline conforming to the combined cross-sectional area resemble the shape of the letter “I” as shown in FIG. 1, where the specific outline conforming is larger than the combined cross-sectional area of the PCB 3 and the side panels 41.

Once the packaged unit, the double-sided PCB 3 and USB head 4, is coupled to the shell element 2, the conductive contacts 30 soldered to the data transmission cable 1 can safely provide an electrical channel for data and power transmission.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A universal serial bus (USB) connector, comprising:
a shell element;
a double sided printed circuit board (PCB); and
a USB head having a frame at one end, two side panels and a crossbeam;
wherein the two side panels extend from the frame, and the crossbeam is transversely interposed between two tips of the two side panels such that the side panels are spaced apart to define a board slot; one end of the PCB is arranged in the frame and another end of the PCB is arranged in the board slot, and the USB head and PCB are fastened at the frame to the shell element.

2. The USB connector as recited in claim 1, wherein the shell element comprises a shell slot conforming to the USB head such that the shell slot encapsulates the frame, and partially sheathes the PCB and the two side panels.

3. The USB connector as recited in claim 2, wherein the shell slot resembles an I-shaped opening.

4. The USB connector as recited in claim 3, wherein the frame further comprises an opening and the printed circuit board is arranged in the opening at a geometrical center of the frame.

5. The USB connector as recited in claim 4, wherein the frame has at least one through hole for fixing the printed circuit board in the frame.

6. The USB connector as recited in claim 5, wherein the PCB has two oppositely arranged surfaces, at least four spaced apart through holes arranged on the PCB, and at least four thin metallic conductive contacts arranged on each of the opposite surfaces, and the conductive contacts on each surface are respectively arranged in the through holes such that the conductive contacts arranged on opposite surfaces are electrically connected and superimposed.

7. The USB connector as recited in claim 6, wherein the USB connector is a Type-A Universal Serial Bus (USB) male connector compatible with a Type-A Universal Serial Bus (USB) female connector.

8. The USB connector as recited in claim 6, wherein the USB head is made of acrylonitrile butadiene styrene.
